(19) United States
(12) Patent Application Publication
(10) Pub. No.: US 2020/0301428 A1
(43) Pub. Date: Sep. 24, 2020

(54) TRAVELLING SUPPORT APPARATUS

(71) Applicant: Toyota Jidosha Kabushiki Kaisha, Toyota-shi (JP)

(72) Inventor: Keiko TOSAKI, Miyoshi-shi (JP)

(73) Assignee: Toyota Jidosha Kabushiki Kaisha, Toyota-shi (JP)

(21) Appl. No.: 16/821,242

(22) Filed: Mar. 17, 2020

(30) Foreign Application Priority Data
Mar. 19, 2019 (JP) 2019-051610

(51) Int. Cl. G05D 1/02

(52) U.S. Cl. CPC G05D 1/0212; G05D 2201/0213; G05D 2201/0212

(57) ABSTRACT

A travelling support apparatus comprises a control unit to perform travelling support control of a vehicle, an input apparatus configured in such a manner that control information is changeable through input operation by a driver, the control information including, for each type of a travelling environment, at least one of feasibility information indicating whether or not performing the travelling support control is permitted and control content information necessary for performing the travelling support control, a storage apparatus to store the control information by associating it with a corresponding type of the travelling environment, and an acquisition apparatus to acquire information on an actual travelling environment. The control unit is configured to identify an actual type of the travelling environment based on the information on an actual travelling environment and to perform the travelling support control in accordance with the control information corresponding to the actual type of the travelling environment.

### TECHNICAL FIELD

The present invention relates to a travelling support apparatus capable of switching whether or not travelling support control is feasible and control contents thereof, the travelling support control including at least either one of driving support control or automatic driving control.

### BACKGROUND ART

A travelling support apparatus to perform travelling support control for a vehicle has been conventionally known, the travelling support control including driving support control to support driving by a driver of the vehicle and/or automatic driving control to automatically run the vehicle without a need of driving by the driver.

The driver can set whether or not to permit performance of the travelling support control by his/her own operation (typically, a switch operation) and further, can set (change) specific control contents for the travelling support control (for example, control parameters necessary for the control).

However, it is not likely that the driver always grasps such setting contents for the travelling support control. As a result, for example, there may arise a situation where travelling support control is not started due to misrecognition by the driver even though travelling environment (surrounding environment during the vehicle travelling, for example, types of roads) of the vehicle has changed and the travelling support control suitable for the changed travelling environment has become feasible.

Alternatively, there may arise a situation where even though the control has been performed, the control content is different from the control content which the driver expects (recognizes) to be performed.

Therefore, a prior-art apparatus identifies feasible travelling support control depending on the travelling environment and presents to the driver the support guidance (inquiry of whether or not to use this control and/or guidance to urge the driver to use this control) for the identified travelling environment (for example, refer to Japanese Patent Application Laid-Open (kokai) No. 2017-117117).

### SUMMARY OF THE INVENTION

However, according to the prior art apparatus, the driver needs to conduct setting operation for the travelling support control every time the support guidance is presented and therefore this setting operation may be a burden to the driver.

The present invention is made to resolve the problem above. That is, one of objects of the present invention is to provide a travelling support apparatus capable of properly switching “whether or not the travelling support control is feasible and/or the control contents thereof”, depending on the travelling environments as well as capable of reducing the driver's burden required for these setting operations.

A travelling support apparatus according to the present invention (hereinafter, also referred to as a “present invention apparatus”) comprises;

a control unit (10) configured to perform travelling support control of a vehicle;

an input apparatus (26, 8320) configured in such a manner that control information is able to be changed through input operation by a driver, the control information including, for each type of a predetermined travelling environment of the vehicle, at least one of feasibility information indicating whether or not performance of the travelling support control is permitted and control content information necessary for performing the travelling support control;

a storage apparatus (S340) configured to store the changed control information by associating it with a corresponding type of the travelling environment; and

an acquisition apparatus (16, 18, 20, 22, 24) configured to acquire information on an actual travelling environment of the vehicle,

wherein,

the control unit (10) is configured to;
identify an actual type of the travelling environment based on the information on an actual travelling environment (S410); and
perform the travelling support control in accordance with the control information stored in the storage apparatus, the control information corresponding to the actual type of the travelling environment.

According to the present invention apparatus, the driver can change (set) in advance the control information including at least the feasibility information and the control content information for each type of the travelling environment of the vehicle. Further, when the actual travelling environment of the vehicle changes, the type of this changed travelling environment is automatically identified and the travelling support control is performed in accordance with the control information corresponding to the type of the travelling environment. Therefore, the driver does not have to conduct the setting operation of the control information every time the travelling environment changes, and the travelling support control is performed (or is prohibited), reflecting the driver's taste for each type of the travelling environment. According to this configuration, “whether or not the travelling support control is feasible and/or the control contents thereof” can be properly switched depending on the travelling environments and that the driver's burden required for these setting operations can be reduced.

In another aspect of the present invention,

the type of the travelling environment is either one of a type of a road, a degree of brightness around the vehicle, and a degree of congestion around the vehicle.

According to this configuration, a suitable type of the travelling environment can be set, depending on the types of the travelling support controls.

In the above description, references used in the following descriptions regarding embodiments are added with parentheses to the elements of the present invention, in order to assist in understanding the present invention. However, those references should not be used to limit the scope of the invention.

### BRIEF DESCRIPTION OF THE DRAWINGS

FIG. 1 is a schematic configuration diagram of a travelling support apparatus according to an embodiment of the present invention.

FIG. 2 is a customize table showing control information of lane departure alert control.

FIG. 3 is a flowchart showing a routine executed by CPU shown in FIG. 1.

FIG. 4 is a flowchart showing a routine executed by CPU shown in FIG. 1.

FIG. 5A is a customize table showing control information of adaptive cruise control.

FIG. 5B is a customize table showing control information of pre-crush brake control.

FIG. 5C is a customize table showing control information of lane change by automatic driving control.

### DESCRIPTION OF THE EMBODIMENT

### First Embodiment

### (Configuration)

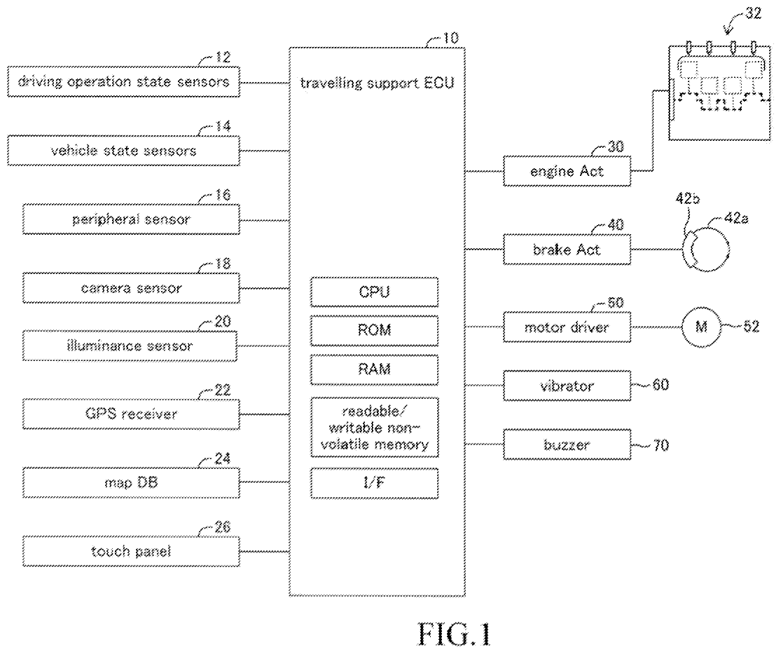

A travelling support apparatus according to an embodiment of the present invention (hereinafter, also referred to as a “present embodiment apparatus”) is applied to a vehicle (hereinafter, also referred to as an “own vehicle” in order to distinguish it from other vehicles). As shown in FIG. 1, the present embodiment apparatus comprises travelling support ECU 10 (hereinafter, also simply referred to as “ECU 10”). The ECU 10 performs a plurality of driving support controls described later as travelling support controls. However, the ECU 10 may be also configured to perform automatic driving control as travelling support control (will be described in a modification example).

ECU is an abbreviation of Electronic Control Unit. The ECU 10 is an electronic control circuit comprising a microcomputer including CPU, ROM, RAM, readable/writable non-volatile memory, interfaces, and the like. The CPU realizes/performs various functions (mentioned later) by executing instructions (i.e. routines) stored in the ROM.

The ECU 10 is connected to sensors 12 to 20 named in the following and acquires (obtains) values (detected values) and information obtained by these sensors every time predetermined time elapses.

The driving operation state sensors 12 include an accelerator operation amount sensor to detect an operation amount of an accelerator pedal, a brake operation amount sensor to detect an operation amount of a brake pedal, a brake switch to detect whether or not the brake pedal has been operated, a steering angle sensor to detect a steering angle, a steering torque sensor to detect steering torque, a direction indicating sensor to detect an operating state of a direction indicator, and the like.

The vehicle state sensors 14 include a vehicle speed sensor to detect a travelling speed of the own vehicle (vehicle speed), a front-rear G sensor to detect an acceleration of the own vehicle in a front-rear direction, a lateral G sensor to detect an acceleration of the own vehicle in a lateral direction, a yaw rate sensor to detect a yaw rate of the own vehicle, and the like.

The peripheral sensor 16 comprises a plurality of radar sensors. Each of the plurality of radar sensors detects an object (an other vehicle, a pedestrian, and the like, for example) present in a front region, a front-right region, a front-left region, a rear-right region, and a rear-left region of the own vehicle.

Each radar sensor is known, and for example, each radar sensor uses an electric wave in a millimeter waveband to obtain information indicating a distance between the own vehicle and the object, a relative speed of the object with respect to the own vehicle, a relative position (direction) of the object with respect to the own vehicle, and so on.

The camera sensor 18 comprises a camera part to image a scenery in front of the own vehicle and a data analyzing part to analyze image data obtained by the camera part.

The data analyzing part recognizes a carriageway marking line of a road (hereinafter, also referred to as a “white line” for convenience sake) and a lane which is a region divided by the white lines. In addition, the data analyzing part obtains a relative position of the own vehicle with respect to the lane. Specifically, the data analyzing part obtains distances in a lane width direction between a position of the own vehicle in a lane on which the own vehicle is travelling (a travelling lane) and the left and right while lines of the travelling lane as a left-side lateral distance dl and a right-side lateral distance dr, respectively. Further, the data analyzing part obtains information on the white lines such as types of the white lines (a solid line or a dashed line) of the travelling lane and an adjacent lane, a distance between adjacent left and right white lines (i.e., a lane width), a shape of each of the white lines, and so on.

The data analyzing part obtains information on an object present in front of the own vehicle. The ECU 10 synthesizes the information obtained by the peripheral sensor 16 and the information obtained by the camera sensor 18 to determine information on an object present around the own vehicle.

The illuminance sensor 20 detects an illuminance sensor value indicating brightness (illuminance) around the own vehicle.

In addition, the ECU 10 is connected to a GPS receiver 22 to receive a GPS signal, a map database 24, and a touch panel (a touch panel type display) 26.

The ECU 10 identifies a position (a latitude and a longitude) of the own vehicle at a current timing based on the GPS signal transmitted from the GPS receiver 22 every time the predetermined time elapses. The ECU 10 displays on the touch panel 26 “a map including the current position of the own vehicle as well as the current position of the own vehicle in that map” based on the position of the own vehicle, map information stored in the map database 24, and so on. This display mode of the touch panel 26 will be referred to as a navigation mode.

The map information stored in the map database 24 includes road information. The road information include types of a road (for example, an interurban expressway, an urban expressway, and a general road) and parameters indicating a position and a shape of a road (for example, a curvature radius or a curvature of a road, a lane width of a road, the number of lanes, a position of a center line of each lane, and the like). The interurban expressway is an expressway connecting one city and an other city. In Japan, “Tomei Expressway”, “Meishin Expressway”, and the like are given as examples. The interurban expressway has a relatively wide lane width and relatively few sharp curves. The urban expressway is an expressway provided in a city. In Japan, “Tokyo Expressway”, “Hanshin Expressway”, and the like are given as examples. The urban expressway has relatively many sharp curves. These expressways are exclusive roads for vehicles. In contrast, the general road is a road other than the express way and is used for transportation for a vehicle, a bicycle, a pedestrian, and the like.

Display modes of the images displayed on the touch panel 26 include a control customize mode in addition to the navigation mode. When the display mode is the control customize mode, a customize table is displayed on the touch panel 26, the customize table being a table for customizing whether or not various types of travelling support controls (mentioned later) are feasible and control contents thereof. A customize button (illustration omitted) is provided in a vicinity of the touch panel 26. When the customize button is pressed by the driver, a customize request signal is transmitted to the ECU 10 and thereby the display mode is switched from the navigation mode to the control customize mode.

Further, the ECU 10 is connected to an engine actuator 30, a brake actuator 40, a motor driver 50, a vibrator 60, and a buzzer 70.

The engine actuator 30 is an actuator for changing a driving state of an internal combustion engine 32 in response to an instruction from the ECU 10. The ECU 10 drives the engine actuator 30 to change torque generated by the internal combustion engine 32 and thereby controls driving force of the own vehicle so as to change an accelerating state (an acceleration). It should be noted that in a case when the own vehicle is a hybrid vehicle, the engine actuator 30 can control the driving force of the own vehicle generated by either one or both of “an engine and a motor” as a vehicle driving source. Further, in a case of when the own vehicle is an electric automobile, the engine actuator 30 can control the driving force of the own vehicle generated by the motor as the vehicle driving source.

The brake actuator 40 adjusts, in response to an instruction from the ECU 10, a hydraulic pressure supplied to a wheel cylinder incorporated in a brake caliper 42b and presses brake pads onto a brake disc 42a with that hydraulic pressure, and thereby generates friction braking force. Accordingly, the ECU 10 can control the braking force of the own vehicle to change a decelerating state (a deceleration) by controlling the brake actuator 40.

The motor driver 50 is connected to a steered motor 52. The steered motor 52 is incorporated in “a steering mechanism (illustration omitted) including a steering wheel, a steering shaft coupled to the steering wheel, a steering gear mechanism, and so on” of the vehicle. The ECU 10 drives the steered motor 52 via the motor driver 50. When the steered motor 52 is driven, torque is applied to the steering mechanism. In this way, the ECU 10 can generate steering assist torque to assist steering operation by the driver as well as change a steering angle of the own vehicle (i.e., a steered angle of steered wheels).

It should be noted that the engine actuator 30, the brake actuator 40, and the motor driver 50 may be connected to an engine ECU, a brake ECU, and an electrically-driven power steering ECU, each illustration thereof being omitted, respectively. In this case, the ECU 10 transmits a control instruction to each of these ECUs and thereby controls the engine actuator 30, the brake actuator 40, and the motor driver 50.

The vibrator 60 vibrates when receiving a vibration signal from the ECU 10 and thereby vibrates the steering wheel so as to draw a driver's attention.

The buzzer 70 makes a sound when receiving a buzzer sound signal from the ECU 10 and thereby draws a driver's attention as well as notify the driver of a state of the travelling support control. It should be noted that the vibrator 60 and the buzzer 70 may be connected to a warning informing ECU. In this case, the ECU 10 transmits to the warning informing ECU a vibration instruction of the vibrator 60 and/or a sound instruction of the buzzer 70.

In the prior-art travelling support apparatus, a plurality of switches are usually arranged in a vicinity of a driver's seat, these switches being used for operating start/termination of the travelling support control and for conducting setting operation of the control contents thereof. Therefore, in a case where surrounding environment during the vehicle travelling (travelling environment) changes and thereby the driver expects a certain arbitrary control to be started or to be terminated or expects the control contents thereof to be changed, the driver him/herself needs to operate the switches corresponding to this control. Accordingly, there may arise a case where the control suitable for the travelling environment will not be performed due to misrecognition by the driver, forgetting of the operation, and the like even though the travelling environment has changed. In addition, the driver needs to conduct operation for each control every time the travelling environment changes and therefore this operation may be a burden to the driver.

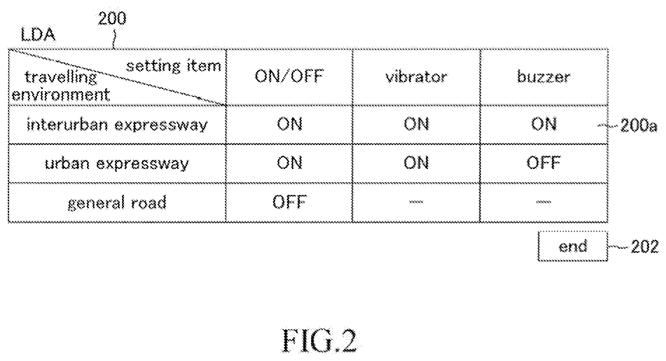

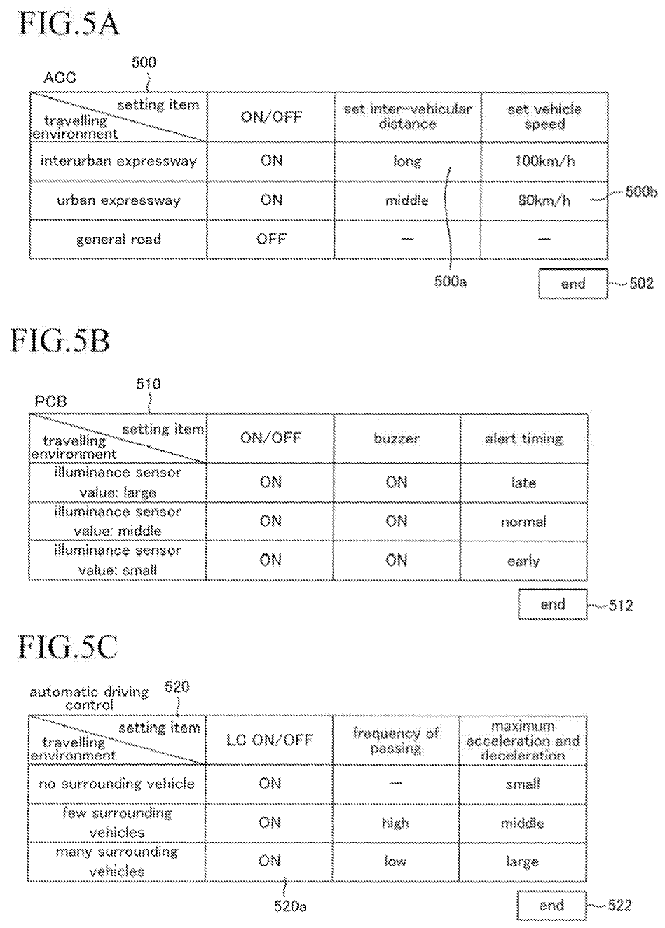

Therefore, the present embodiment apparatus is configured in such a manner that the driver can set, in advance, “whether or not each of the travelling support controls is feasible and the control contents thereof” using the customize tables (refer to FIG. 2, FIG. 5A, and FIG. 5B). Each of the customize tables associates “whether or not a corresponding control is feasible and the control contents thereof” with the travelling environment. Hereinafter, “whether or not a certain arbitrary control is feasible” will be also simply referred to as “ON/OFF of the control” or “ON/OFF”. Each of the customize tables is configured to be customizable by the driver via the touch panel 26. The ECU 10 identifies the travelling environment at a current point in time. In a case when ON/OFF of a certain arbitrary control in the corresponding customize table associated with the travelling environment at the current point in time is “ON (feasible)” as well as a performing condition of this control is satisfied, the ECU 10 performs this control in accordance with the control contents associated with this travelling environment. According to this configuration, the ECU 10 automatically switches, depending on the travelling environment, ON/OFF of each control and the control contents thereof by referring to the customize tables customized by the driver in advance. Therefore, a possibility that control suitable for the travelling environment is not performed can be significantly reduced as well as a driver's operation burden associated with switching of types of the controls and the control contents thereof can be lightened. Detailed description will be made below.

### (Customize Table)

FIG. 2 shows a customize table 200 in a case where a type of the travelling support controls is “lane departure alert control which is a type of the driving support controls (hereinafter, also referred to as “LDA”)”. As shown in the customize table 200, each customize table indicates content of each setting item for every travelling environment. When a type of the driving support controls is the LDA, the travelling environments are types of roads on which the own vehicle travels. In an example of FIG. 2, the types of the roads are categorized into an interurban expressway, an urban expressway, and a general road.

Among a plurality of setting items, a setting item of “ON/OFF” indicates whether or not the LDA is feasible (that is, whether or not the LDA is performed when an LDA performing condition is satisfied). The LDA is known control to raise an alarm when a vehicle is likely to deviate from a lane (a region between left and right carriageway marking lines) under a state where the direction indicator is not blinking. The LDA performing condition is a condition necessary to perform the LDA and becomes satisfied when following two conditions are both satisfied.
The operating state of the direction indicator is in an off state.
At least one of the left-side lateral distance dl and the right-side lateral distance dr is less than a threshold.

Therefore, in a case when the setting item of the “ON/OFF” indicates “ON (feasible)”, the LDA is performed when the LDA performing condition is satisfied whereas the LDA is not performed when the LDA performing condition is not satisfied. On the other hand, in a case when the setting item of the “ON/OFF” indicates “OFF (not feasible)”, the LDA is not performed regardless of whether or not the LDA performing condition being satisfied.

Setting items of “vibrator” and “buzzer” indicate control contents of the LDA (specifically, types of alarms of when the LDA is performed). When the setting item of “vibrator” indicates “ON”, an alarm using the vibrator 60 is raised whereas when the setting item thereof indicates “OFF”, the alarm using the vibrator 60 is not raised. When the setting item of “buzzer” indicates “ON”, an alarm using the buzzer 70 is raised whereas when the setting item thereof indicates “OFF”, the alarm using the buzzer 70 is not raised.

FIG. 2 indicates the contents of the customize table 200 in an initial setting state. In general, the LDA is often used on the expressway whereas is not used very often on the general road. Therefore, when the travelling environment is either the interurban expressway or the urban expressway, the setting item of the “ON/OFF” is each set as “ON” whereas when the travelling environment is the general road, the setting item thereof is set as “OFF”.

Besides, there are relatively many sharp curves on the urban expressway and therefore the LDA is performed relatively frequently. Accordingly, if alarms are raised using both of the vibrator 60 and the buzzer 70, it is likely that the driver may feel annoyed. Therefore, when the travelling environment is the urban expressway, the setting items of the “vibrator” and the “buzzer” are set as “ON” and “OFF”, respectively in the initial setting state. On the other hand, there are relatively few sharp curves on the interurban expressway and therefore the LDA is performed less frequently. Accordingly, it is desirable that the alarms are raised using both of the vibrator 60 and the buzzer 70. Therefore, when the travelling environment is the interurban expressway, the setting items of the “vibrator” and the “buzzer” are both set as “ON” in the initial setting state.

### (How to Customize the Customize Table)

The driver can customize (change/set) the content of each of the setting items in the customize table 200 to a desired content. Specifically, when the driver presses the above-mentioned customize button, the display mode of the touch panel 26 is set to be the control customize mode and the customize tables for the corresponding travelling support controls including the customize table 200 are all displayed on the touch panel 26. The driver can change the content of each cell by touching (in other words, conducting an input operation for) a cell for which the driver desires to customize on the touch panel 26. For example, when the driver does not desire the buzzer 70 to make a sound as an alarm performed by the LDA in a case of the travelling environment being the interurban expressway, the driver may touch a cell 200a to change a content thereof from “ON” to “OFF”.

Each of the customize tables including the customize table 200 includes a completion switch (a completion switch 202, for example). When any one of the completion switches (the completion switch 202, for example) is touched by the driver, indication of all the customize tables including the customize table 200 is ended, and the display mode of the touch panel 26 is set to be the navigation mode. At this time, the transmission of the customize request signal to the ECU 10 is stopped. Further, the contents in these customize tables are stored in the readable/writable non-volatile memory of the ECU 10. That is, “ON/OFF of each control and the control content thereof (hereinafter, also referred to as “control information”)” included in the displayed customize tables is stored by associating with a type of control corresponding to this control information and a travelling environment corresponding to this control information.

### (Specific Operation)

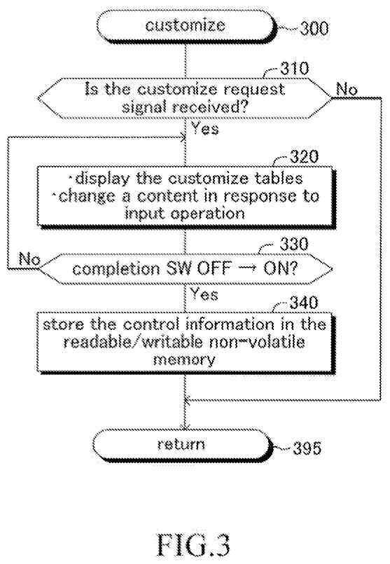

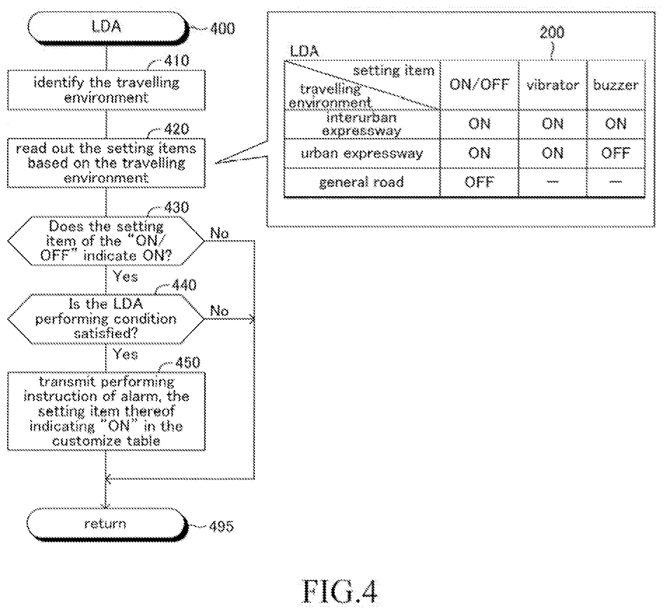

Next, specific operation of the ECU 10 will be described, taking the LDA for an example. The CPU of the ECU 10 performs routines shown by flowcharts in FIG. 3 and FIG. 4 every time a predetermined interval elapses.

When a predetermined timing arrives, the CPU initiates processing from a step 300 in FIG. 3 and proceeds to a step 310 to determine whether or not the customize request signal is received. When the customize request signal is not received, the CPU makes a “No” determination at the step 310 and proceeds to a step 395 to tentatively terminate the present routine. On the other hand, when the customize request signal is received, the CPU makes an “Yes” determination at the step 310 and proceeds to a step 320 to display the customize tables for all the controls including the customize table 200. At this time, when the driver conducts the input operation mentioned earlier, the CPU changes a corresponding content in the customize table in response to this input operation.

Subsequently, the CPU proceeds to a step 330 to determine whether or not any one of the completion switches of the customize tables is touched by the driver and thereby a status of the completion switch touched has changed from an off state to an on state. When none of the completion switches has changed into the on state, the CPU makes a “No” determination at the step 330 to return to the step 320.

When the status of any one of the completion switches has changed from the off state to the on state, the CPU makes an “Yes” determination at the step 330 to end the indication of the customize tables. Next, the CPU proceeds to a step 340 to store, for every control, the contents in the customize tables (i.e., the control information) in the readable/writable non-volatile memory by associating it with the travelling environment as described above. Thereafter, the CPU proceeds to the step 395 to tentatively terminate the present routine.

On the other hand, when the predetermined timing arrives, the CPU initiates processing from a step 400 in FIG. 4 and performs processing of a step 410 and a step 420 in this order.

Step 410: The CPU identifies, based on the GPS signal and the map information, what type of the roads the own vehicle is currently travelling on among the interurban expressway, the urban expressway, and the general road. That is, the CPU identifies the travelling environment regulated for the LDA.

Step 420: The CPU refers to the control information corresponding to the customize table 200 stored in the readable/writable non-volatile memory to read out contents of the setting items (the “ON/OFF”, the “vibrator”, and the “buzzer”) associated with the travelling environment identified at the step 410.

Subsequently, the CPU proceeds to a step 430 to determine whether or not the setting item of the “ON/OFF” read out at the step 420 indicates “ON”. When the setting item of the “ON/OFF” indicates “OFF”, the CPU makes a “No” determination at the step 430 and proceeds to a step 495 to tentatively terminate the present routine. As a result, the LDA is not performed.

On the other hand, when the setting item of the “ON/OFF” indicates “ON”, the CPU makes an “Yes” determination at the step 430 and proceeds to a step 440 to determine whether or not the LDA performing condition mentioned above is satisfied. When the LDA performing condition is not satisfied, the CPU makes a “No” determination at the step 440 and proceeds to the step 495 to tentatively terminate the present routine.

On the other hand, when the LDA performing condition is satisfied, the CPU makes an “Yes” determination at the step 440 and proceeds to a step 450 to transmit to a corresponding apparatus(es) performing instruction of an alarm(s), a setting item(s) thereof indicating “ON”. Note that this/these setting item(s) being an item(s) indicating the control content(s) (i.e., the setting items of the “vibrator” and the “buzzer”) among the setting items read out at the step 420. In the example of FIG. 2, when the travelling environment has been identified as the interurban expressway, the CPU transmits, at the step 450, the performing instructions of the alarms to the vibrator 60 and to the buzzer 70. In this way, the vibrator 60 vibrates as well as the buzzer 70 makes a sound. In contrast, when the travelling environment has been identified as the urban expressway, the CPU, at the step 450, transmits to the vibrator 60 the performing instruction of the alarm whereas does not transmit to the buzzer 70 the performing instruction of the alarm. In this case, the vibrator 60 vibrates whereas the buzzer 70 does not make a sound. Thereafter, the CPU proceeds to the step 495 to tentatively terminate the present routine.

### (Other Driving Support Controls)

As described earlier, the present embodiment apparatus is configured to be able to perform, in addition to the LDA, the adaptive cruise control and the pre-crash brake control as the driving support controls. Hereinafter, the adaptive cruise control and the pre-crash brake control will be referred to as “ACC” and “PCB”, respectively. Brief descriptions on how to customize, control contents, and the like for these controls will be made below.

### (ACC)

As shown in a customize table 500 for the ACC in FIG. 5A, setting items of the ACC are “ON/OFF”, “set inter-vehicular distance”, and “set vehicle speed”. Besides, travelling environments thereof are the same as those of the LDA, that is, types of the roads on which the own vehicle travels. It should be noted that the customize table 500 indicates contents in the initial setting state.

Among the plurality of setting items, the setting item of the “ON/OFF” indicates whether or not the ACC is feasible. The ACC is a known control to make the own vehicle travel at a constant speed in such a manner that an actual vehicle speed matches with a set vehicle speed when there is no vehicle (a preceding vehicle) travelling ahead of the own vehicle while when a preceding vehicle exists, to make the own vehicle travel in such a manner that an inter-vehicular distance with the preceding vehicle acquired from the peripheral sensor 16 matches with a set inter-vehicular distance.

Therefore, when the setting item of the “ON/OFF” indicates “ON (feasible)” as well as an ACC performing condition is satisfied, the ACC is performed, and when the setting item thereof indicates “OFF (not feasible)”, the ACC is not performed. For example, the ACC performing condition becomes satisfied when the vehicle speed sensor, the peripheral sensor 16, and the camera sensor 18 are all in normal states.

Among the plurality of setting items of the ACC, the setting items of the “set inter-vehicular distance” and the “set vehicle speed” indicate control contents of the ACC, and more specifically, indicate the set inter-vehicular distance and the set vehicle speed of when the ACC is performed, respectively. The setting item of the “set inter-vehicular distance” includes options of “long, middle, short”. An inter-vehicular distance [m] corresponding to each option has been stored in advance in the ROM of the ECU 10 as the set inter-vehicular distance. The setting item of the “set vehicle speed” is an item where arbitrary vehicle speed [km/h] within a predetermined range is to be set.

The customize table 500 can be customized in a similar manner to the customize table 200. For instance, when the driver wishes to shorten the set inter-vehicular distance in a case of the travelling environment being the interurban expressway, the driver may touch a cell 500a to change a content of the cell 500a from “long” to “middle” or from “middle” to “short”. The content of the cell 500a is switched to “long”, “middle”, and “short” in order every time the cell 500a is touched. When the cell 500a is touched once when the content indicates “short”, the content is switched from “short” to “long”. On the other hand, for example, when the driver wishes to change the set vehicle speed in a case of the travelling environment being the urban expressway, the driver may touch a cell 500b. This way, an upward arrow, a downward arrow, and a current set vehicle speed (Illustrations are all omitted.) are displayed. The current set vehicle speed gradually increases during a period in which the upward arrow is being touched whereas the current set vehicle speed gradually decreases during a period in which the downward arrow is being touched.

The customize table 500 includes a completion switch 502. When the completion switch 502 is touched by the driver, the contents in all of the customize tables including the customize table 500 are stored in the readable/writable non-volatile memory of the ECU 10 in a similar way to a case when any one of other completion switches is touched.

The customize processing of the customize table 500 for the ACC is executed by the routine shown in FIG. 3. The ACC is performed when the CPU executes processing of a non-illustrated routine similar to the routine shown in FIG. 4. Briefly speaking, the CPU executes following processing.
The CPU identifies the types of the roads (i.e., the travelling environments) by executing processing similar to the processing at the step 410.
The CPU refers to control information corresponding to the customize table 500 to read out the contents of the setting items (the “ON/OFF”, the “set inter-vehicular distance”, and the “set vehicle speed”) associated with the travelling environment identified by executing processing similar to the processing at the step 420.
When the setting item of the “ON/OFF” read out indicates “ON”, the CPU executes the above-mentioned control using either one of the set inter-vehicular distance and the set vehicle speed read out. That is, the CPU makes the own vehicle travel using the engine actuator 30 and the brake actuator 40 as described above.

### (PCB)

As shown in a customize table 510 for the PCB in FIG. 5B, setting items of the PCB are “ON/OFF”, “buzzer”, and “alert timing”. Besides, travelling environments thereof are degrees of brightness around the own vehicle. The brightness is based on an illuminance sensor value acquired from the illuminance sensor 20. More specifically, the travelling environments are categorized into “the illuminance sensor value: large” (when the value is large), “the illuminance sensor value: middle” (when the value is middle), and “the illuminance sensor value: small” (when the value is small).

Among the plurality of setting items, the setting item of the “ON/OFF” indicates whether or not the PCB is feasible. The PCB is a known control to raise an alarm to alert the driver when an object with a high possibility of colliding with the own vehicle exists and thereafter to automatically generate braking force when the possibility of the collision becomes higher. Here, “when an object with a high possibility of colliding with the own vehicle exists” means a case when a time to collision (i.e., a time expected for the own vehicle to collide with that object) with that object becomes less than or equal to a predetermined first time threshold, and “when the possibility of the collision becomes higher” means a case when the time to collision with the object becomes less than or equal to a predetermined second time threshold shorter than the first time threshold. It should be noted that the time to collision can be calculated, based on information acquired from the peripheral sensor 16, by dividing a “front-rear direction component of a distance to the object” by a “front-rear direction component of a relative speed of the own vehicle with respect to the object”. Based on the above, a PCB performing condition becomes satisfied when the time to collision to the object is less than or equal to the first time threshold.

Therefore, in a case when the setting item of the “ON/OFF” indicates “ON (feasible)”, the PCB is performed when the PCB performing condition is satisfied whereas the PCB is not performed when the PCB performing condition is not satisfied. On the other hand, in a case when the setting item of the “ON/OFF” indicates “OFF (not feasible)”, the PCB is not performed regardless of whether or not the PCB performing condition being satisfied.

Among the plurality of setting items of the PCB, the setting items of the “buzzer” and the “alert timing” indicate control contents of the PCB, and more specifically, indicate a type of an alarm and a timing at which the alarm is raised (that is, a value of the first time threshold), respectively.

In a case when the setting item of the “buzzer” indicates “ON”, the alarm is raised by sounding the buzzer 70 when the time to collision is less than or equal to the first time threshold, and thereafter, when the time to collision is less than or equal to the second time threshold, the control to automatically generate the breaking force is performed along with the alarm by the buzzer 70. On the other hand, in a case when the setting item of the “buzzer” indicates “OFF”, the alarm by the buzzer 70 is not raised even though the time to collision is less than or equal to the first time threshold whereas the control to automatically generate the braking force is performed when the time to collision is less than or equal to the second time threshold.

The setting item of the “alert timing” includes options of “late, normal, early”. A first time threshold [s] corresponding to each option has been stored in advance in the ROM of the ECU 10. The values of these first time thresholds have been set to increase as the options change into “late”, “normal”, “early” in this order.

The customize table 510 can be customized in a similar manner to the customize table 200. The customize table 510 includes a completion switch 512. When the completion switch 512 is touched by the driver, the contents in all of the customize tables including the customize table 510 are stored in the readable/writable non-volatile memory of the ECU 10 in a similar way to a case when any one of other completion switches is touched.

The PCB is often used regardless of the brightness around the own vehicle. Therefore, when the customize table 510 is in the initial setting state, the setting item of the “ON/OFF” has been set to “ON” regardless of the travelling environments.

On the other hand, the driver can visually recognize an object in a farther region as it becomes lighter around the own vehicle, which enables the driver to perform various types of operations to avoid a collision by him/herself at a timing when the time to collision is relatively long. Here, the various types of operations are an operation of depressing the brake pedal or an operation of the steering wheel, for example. Therefore, when the customize table 510 is in the initial setting state, the alert timing is set in such a manner that the buzzer 70 may not make a sound by the PCB in advance of the collision avoidance operation by the driver him/herself. That is, the alert timing is set in such a manner that the alert timing becomes late as the illuminance sensor value increases. Thereby, a frequency that the driver feels annoyed with the alarm can be reduced.

The customize processing of the customize table 510 for the PCB is executed by the routine shown in FIG. 3. The PCB is performed when the CPU executes processing of a non-illustrated routine similar to the routine shown in FIG. 4. Briefly speaking, the CPU executes following processing.
The CPU first acquires an illuminance sensor value from the illuminance sensor 20 to identify into which category of the illuminance sensor value (large, middle, small) the acquired illuminance sensor value applies.
The CPU refers to control information corresponding to the customize table 510 to read out the contents of the setting items (the “ON/OFF”, the “buzzer”, and the “alert timing”) associated with the travelling environment identified by executing processing similar to the processing at the step 420.
When the setting item of the “ON/OFF” read out indicates “ON” as well as the setting item of the “buzzer” read out indicates “ON”, the CPU reads out the threshold time (set in advance) from the ROM as the first time threshold, this threshold time corresponding to the “alert timing” read out. Thereafter, the CPU raises an alarm for the PCB using this first time threshold as described above. It should be noted that the second time threshold is a constant value set in advance.

### Modification Example

ECU 10 according to a modification example is configured to perform automatic driving control as the travelling support control and to customize whether or not this automatic driving control is feasible and control contents thereof by using a customize table 520 shown in FIG. 5C as will be described below.

### (Automatic Driving Control)

When the driver presses a non-illustrated customize button for automatic driving, the display mode is switched from the navigation mode to the control customize mode, and as a result, the customize table 520 for the automatic driving control is displayed on the touch panel 26 as shown in FIG. 5C. As shown in this table, the setting items of the automatic driving control are “LC ON/OFF”, “frequency of passing”, and “maximum acceleration and deceleration”. It should be noted that the customize table 520 indicates contents in the initial setting state.

Travelling environments concerning the automatic driving control is a degree of congestion of other vehicles (surrounding vehicles) travelling in a surrounding area of the own vehicle. The degree of congestion is determined by a number of the surrounding vehicles present in a predetermined region surrounding the own vehicle. More specifically, the travelling environments concerning the automatic driving control is classified into a case where there is no surrounding vehicle (“no surrounding vehicle”), a case where there are relatively few surrounding vehicles (“few surrounding vehicles”), and a case where there are relatively many surrounding vehicles (“many surrounding vehicles”).

Among the plurality of setting items, the setting item of the “LC ON/OFF” indicates whether or not lane change by the automatic driving control is feasible. The lane change by the automatic driving control will be simply referred to as “automatic lane change”. More specifically, the setting item of the “LC ON/OFF” indicates “whether or not the automatic driving control is performed when a performing condition of the automatic lane change (hereinafter, simply referred to as a “lane change performing condition”) is satisfied”. The automatic lane change is control to monitor the surrounding of the own vehicle and when it is determined that safe lane change is possible, to make the own vehicle automatically travel in such a manner that the own vehicle moves from the travelling lane to a lane on a lane change direction side (hereinafter, referred to as a “target lane”). The automatic lane change includes lane change for passing a preceding vehicle. Therefore, the lane change performing condition becomes satisfied when following conditions A, B, and C are all satisfied. The ECU 10 determines, based on the information acquired from the camera sensor 18, whether or not each of the condition A and the condition B is satisfied.

Condition A: A white line at a boundary between the travelling lane and the target lane is a dashed line.

Condition B: An inter-vehicular distance to the preceding vehicle which is a target to be passed is less than or equal to a predetermined distance.

Condition C: The surrounding of the own vehicle is in a state where the safe lane change is possible.

It should be noted that the condition B may be any other conditions where the lane change would be necessary. For example, the condition B may include a condition that “there is a need to enter a branched road (including an interchange, a junction, and the like) based on a navigation”.

Besides, the ECU 10 determines that the above condition C becomes satisfied when the ECU 10 estimates, based on a relative speed of an other vehicle travelling on the target lane and a distance to this other vehicle, both of which being obtained from the peripheral sensor 16, that the inter-vehicular distance to the other vehicle is more than or equal to a predetermined inter-vehicular distance threshold in a case when performing the automatic lane change, maintaining a current vehicle speed.

Therefore, when the lane change performing condition is satisfied in a case when the setting item of the “LC ON/OFF” indicates “ON (feasible)”, the automatic lane change is performed, while when the lane change performing condition is not satisfied even though the setting item of the “LC ON/OFF” indicates “ON (feasible)”, the automatic lane change is not performed. In addition, in a case when the setting item of the “LC ON/OFF” indicates “OFF (not feasible)”, the automatic lane change is not performed regardless of whether or not the lane change performing condition being satisfied.

Among the setting items for the automatic driving control, the items of the “frequency of passing” and the “maximum acceleration and deceleration” indicates the control contents for the automatic lane change. More specifically, the “frequency of passing” indicates how frequently the own vehicle will passe a preceding vehicle when the automatic lane change is performed, and the “maximum acceleration and deceleration” indicates an upper limit value of a magnitude of an acceleration of the own vehicle when the automatic driving control is performed.

The setting item of the “frequency of passing” includes options of “high, middle, low”. An inter-vehicular distance threshold [m] corresponding to each option has been stored in advance in the ROM of the ECU 10. The values of these inter-vehicular distance thresholds have been set to increase as the options change into “high”, “middle”, “low” in this order. For example, when the setting item of the “frequency of passing” indicates “high”, the inter-vehicular distance threshold is set to a smallest inter-vehicular distance threshold among these three inter-vehicular distance thresholds stored in the ROM. Accordingly, the aforementioned condition C becomes likely to be satisfied and therefore the automatic lane change comes to be performed relatively frequently. It should be noted that in a case when the travelling environment is the “no surrounding vehicle”, the preceding vehicle which is a target to be passed does not exist, and thus a content of the setting item of the “frequency of passing” is set to be immutable.

The setting item of the “maximum acceleration and deceleration” includes options of “large, middle, small”. An upper limit value of a magnitude of an acceleration corresponding to each option has been stored in advance in the ROM of the ECU 10. These upper limit values have been set to decrease as the options change into “large”, “middle”, “small”, in this order. When performing the automatic driving control, the ECU 10 makes the own vehicle travel such that a magnitude of an actual acceleration thereof does not become more than or equal to the corresponding upper limit value. Therefore, when the setting item of the “maximum acceleration and deceleration” indicates “large”, relatively rapid acceleration and deceleration become possible, which makes a movement of the own vehicle by the automatic driving control quick (speedy). On the other hand, when the setting item of the “maximum acceleration and deceleration” indicates “small”, relatively moderate acceleration and deceleration are performed, which makes the movement of the own vehicle by the automatic driving control smooth.

The customize table 520 can be customized in a similar manner to the customize table 200. For example, when the driver does not desire the lane change under the travelling environment of the “many surrounding vehicles”, the driver may touch a cell 520a to change a content thereof to “OFF”.

The customize table 520 includes a completion switch 522. When the completion switch 522 is touched by the driver and thereby a state thereof changes from the off state to the on state, the display mode is switched to the navigation mode, and thus the indication of the customize table 520 is ended. At this time, the control information in the customize table 520 is stored in the readable/writable non-volatile memory of ECU 10.

The customize processing of the customize table 520 for the automatic driving control is executed by the CPU executing a non-illustrated routine similar to the routine shown in FIG. 3. The automatic driving control is performed by the CPU executing a non-illustrated routine similar to the routine shown in the FIG. 4. Briefly, the CPU executes following processing.
First, the CPU calculates a number of surrounding vehicles based on the information acquired from the peripheral sensor 16 and the camera sensor 18.
When the number of the surrounding vehicles is zero, the CPU determines that the travelling environment is the “no surrounding vehicle”.
When the number of the surrounding vehicles is greater than zero and is less than or equal to a predetermined number threshold, the CPU determines that the travelling environment is the “few surrounding vehicles”.
When the number of the surrounding vehicles is greater than the number threshold, the CPU determines that the travelling environment is the “many surrounding vehicles”.
It should be noted that the ECU 10 may identify these travelling environments via known communications such as a road-vehicle communication or a communication with a traffic center.
The CPU refers to the control information corresponding to the customize table 520 just like the processing at the step 420 and thereby reads out the contents of the setting items (the “frequency of passing” and the “maximum acceleration and deceleration”) associated with the identified travelling environment.
When the setting item (LC ON/OFF) read out indicates “OFF”, the CPU continues the automatic driving control without performing the automatic lane change.
The CPU determines whether or not the conditions A and B are satisfied.
When the setting item (LC ON/OFF) read out indicates “ON”, the CPU determines whether or not the condition B is satisfied using the inter-vehicular distance threshold (set in advance), this threshold value corresponding to the “frequency of passing” read out.
When the setting item (LC ON/OFF) read out indicates “ON” as well as it is determined that all of the conditions A, B, and C are satisfied, the CPU performs the automatic lane change in such a manner that the magnitude of the actual acceleration of the own vehicle does not exceed the upper limit value corresponding to the “maximum acceleration and deceleration” read out.

As described above, according to the present embodiment apparatus and a modification example thereof, the control information of the travelling support controls (the driving support controls or the automatic driving control) is automatically switched, every time the travelling environment changes, to the control information corresponding to the changed travelling environment.

Therefore, proper travelling support control suitable for each travelling environment can be performed.

In addition, it becomes possible for the driver to customize in advance the ON/OFF of each of the travelling support controls, the control contents thereof, and the like according to his/her taste. Thus, the travelling support control reflecting the driver's taste can be performed for each travelling environment.

The present invention is not limited to the aforementioned embodiment and modification example and may adopt various modifications within a scope of the present invention.

For example, the customize table may include other setting items in place of or in addition to the setting items named in the above embodiment. As one example, the customize table 510 may include a setting item of a “display” in addition to the “buzzer” as a type of alarms. In this case, when the setting item of the “display” indicates “ON”, an alert mark is indicated on a non-illustrated display in a case when the time to collision is less than or equal to the first time threshold, whereas when the setting item of the “display” indicates “OFF”, this alert mark is not indicated.

In addition, a sensor, an apparatus, and database used for identifying the travelling environments is not limited to those used in the above embodiment. For example, the travelling environments may be types of weather (not raining, raining, and so on). In this case, the own vehicle may identify the travelling environments (i.e., the types of weather) of the own vehicle using a raindrop sensor configured to detect raindrops. Further, the travelling environments may be types of temperature (high temperature, normal temperature, low temperature, and so on). In this case, the own vehicle may identify the travelling environments (i.e., the types of temperature) of the own vehicle using an outside-air temperature sensor configured to detect outside-air temperature.

Further, a layout of the customize tables and the completion switches is not limited the layout in the above embodiment. For example, one completion switch may be displayed on the touch panel 26. Besides, in the above embodiment, when the customize button is pressed, the customize table for each control is displayed. However, a configuration is not limited thereto. For example, when the customize button is pressed, only the types of the controls may be displayed, and after the driver selects one type of control for which he/she desires to customize, a customize table for the control selected may be displayed.

Further, an ID (identification mark) of each driver may be registered in the readable/writable non-volatile memory of the ECU 10, and the customize tables may be stored by associating them with the driver's ID. In this case, when the driver inputs his/her own ID through a pre-arranged input apparatus, the driver support control or the automatic driving control is performed based on the customize tables associated with this ID, which improve the convenience.

Further, more than or equal to one customize table among a plurality of customize tables may include only the ON/OFF of each control as a setting item or may include only the control contents of each control as the setting items.

Further, a number of the travelling support controls which are able to be customized may be one (for example, only ACC).

Further, when the travelling support apparatus is configured to perform both of the driving support control and the automatic driving control, either one of the driving support control or the automatic driving control may be first selected through a selecting operation by the driver, and the control selected may be performed in accordance with a corresponding customize table.

1. A travelling support apparatus comprising:
a control unit configured to perform travelling support control of a vehicle;
an input apparatus configured in such a manner that control information is able to be changed through input operation by a driver, said control information including, for each type of a predetermined travelling environment of said vehicle, at least one of feasibility information indicating whether or not performance of said travelling support control is permitted and control content information necessary for performing said travelling support control;
a storage apparatus configured to store said changed control information by associating it with a corresponding type of said travelling environment; and
an acquisition apparatus configured to acquire information on an actual travelling environment of said vehicle,
wherein,
said control unit is configured to;
identify an actual type of said travelling environment based on said information on an actual travelling environment; and
perform said travelling support control in accordance with said control information stored in said storage apparatus, said control information corresponding to said actual type of said travelling environment.

2. The travelling support apparatus according to claim 1, wherein,
said type of said travelling environment is either one of a type of a road, a degree of brightness around said vehicle, and a degree of congestion around said vehicle.
